(19) United States
(12) Patent Application Publication
(10) Pub. No.: US 2011/0081069 A1
(43) Pub. Date: Apr. 7, 2011

(54) Optical Simulation Site Determination

(76) Inventors: MOHAMED BAHNAS, Cairo (EG); Mohamed Al-Imam, Cairo (EG)

(21) Appl. No.: 12/899,357

(22) Filed: Oct. 6, 2010

Related U.S. Application Data
(60) Provisional application No. 61/249,225, filed on Oct. 6, 2009.

(51) Int. Cl. G06K 9/48

(52) U.S. Cl. 382/144; 382/199

(57) ABSTRACT

The length of an optical simulation site for an edge fragment may be determined based on the maximum and minimum intensity locations near the edge fragment. The width/space centerline's location may be used to approximate the minimum/maximum intensity location. The methods help reduce the optical proximity correction runtime without sacrificing the optical proximity correction output quality.

### RELATED APPLICATIONS

This application claims priority to U.S. Provisional Patent Application No. 61/249,225, entitled “Optical Process Correction Site Shrinking,” filed on Oct. 6, 2010, and naming Mohamed Bahnas and Mohamed Al-Imam as inventors, which application is incorporated entirely herein by reference.

### FIELD OF THE INVENTION

The present invention is directed to semiconductor manufacturing. Various aspects of the invention may be particularly useful for determining simulation site length.

### BACKGROUND OF THE INVENTION

Photolithography is a key enabler for high throughput fabrication in semiconductor microelectronics. Millions of patterns are drawn on a mask, and then transferred to a silicon wafer by light exposure of the mask. The fidelity of the image transferred to silicon is highly dependent on the relationship between the wavelength of the exposure light and the dimensions of the patterns that need to be transferred to silicon. When the exposure wavelength is considerably larger than pattern dimensions, the image on the wafer (the printed image) will be distorted. To compensate for these distortions, Optical Proximity Correction “OPC” is often applied to the mask. During OPC, the edges of the polygons are broken into smaller fragments, and these fragments are allowed to move individually in the direction orthogonal to their extensions. For each fragment the difference between the printed image due to the current fragment position and the desired image is calculated, and the algorithm that controls the fragment movements adjusts the fragment position such that the printed image would be as close as possible to the desired image.

There are different kinds of OPC; the sparse OPC is one in which the optical simulations are performed at sparse locations usually defined relative to edge fragments in a layout. During the sparse OPC process, each fragment is assigned a number of points, referred to as control points. These control points are locations where the aerial image intensity is calculated and sampled. An increase in the number of control points will increase the number of optical simulations and consequently increase the total simulation time. On the other hand, a sufficient number of control points are needed for a resist model to accurately predict the printed image using the intensities calculated at the control points. Therefore, it is desirable to search for an optimal number of control points for each edge fragment in the sparse OPC.

### BRIEF SUMMARY OF THE INVENTION

Aspects of the invention relate to determining simulation site length for an edge fragment in a design layout. The simulation site should be long enough to include a sufficient number of control points for an intended application but not too long to increase runtime unnecessarily. In various embodiments of the invention, the maximum and minimum intensity locations near an edge fragment are determined first. The simulation site length is then determined based on the maximum and minimum intensity locations. According to some resist models, simulation points beyond the maximum and minimum locations may be redundant. The optical simulation site length and the corresponding control points may be determined accordingly. It is observed that the maximum and minimum intensity locations are near the centerlines of the space and width adjacent to the edge fragment. Here, the space refers to the space between the edge fragment and an edge fragment that belongs to the edge fragment's immediate neighboring feature that faces the edge fragment, while the width refers to the space between the edge fragment and an edge fragment that belongs to the same feature and that faces the edge fragment. With some implementations of the invention, the space/width centerline's location is used to approximate the maximum/minimum intensity location.

### BRIEF DESCRIPTION OF THE DRAWINGS

FIG. 1 illustrates an optical simulation site and its control points.

FIG. 2 illustrates centerlines (dotted lines) of width and space, an intensity curve and the maximum and minimum intensity locations.

FIG. 3 illustrates an intensity curve for a line-end structure.

FIG. 4 illustrates saturation of intensity curves for very wide structures in Att-RSM masks.

### DETAILED DESCRIPTION OF THE INVENTION

Various aspects of the present invention relate to optical simulation site determination. In the following description, numerous details are set forth for the purpose of explanation. However, one of ordinary skill in the art will realize that the invention may be practiced without the use of these specific details. In other instances, well-known features have not been described in details to avoid obscuring the present invention.

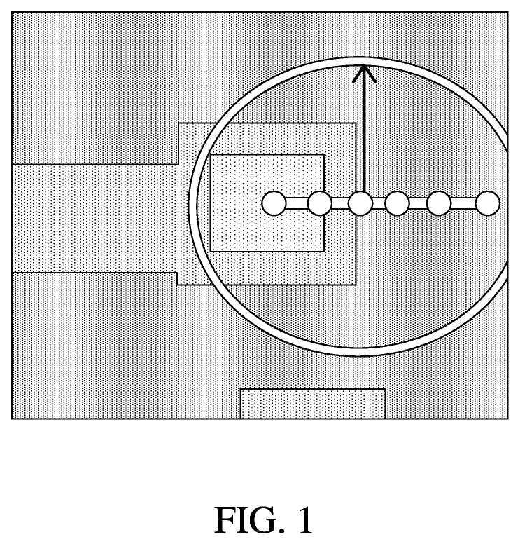

The sparse simulation engine employed in the sparse OPC plots an intensity curve for each edge fragment. The intensity curve is formed by plotting the intensity values of several sparse control points as shown by white dots in FIG. 1. These control points collectively present the simulation site of the fragment. The site length corresponds to the number of control points since the control points are often placed with a certain constant spacing along the simulation site. The intensity of each control point is calculated by performing optical simulation within the optical proximity neighborhood as illustrated by the white circle for one control point in FIG. 1. As discussed previously, the simulation site should be long enough to obtain sufficient optical simulation data for accurate resist model prediction of the edge printing threshold.

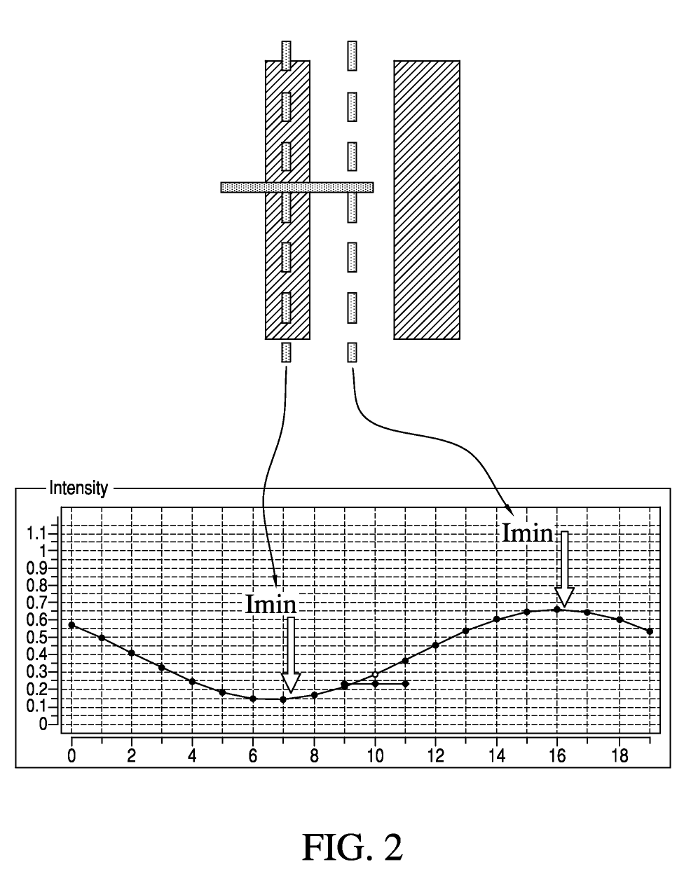

The variable threshold resist model (VT5) calculation, described in Y. Granik and N. Cobb, “New process models for OPC at sub-90-nm nodes”, Proc. SPIE 5040, (2003), which is incorporated herein by reference, depends on some characteristics of the intensity curve for each fragment such as the local maximum and minimum intensity values (Iₘₐₓ and Iₘᵢₙ respectively) as shown in FIG. 2. Any simulation points on the intensity curve that are beyond these maximum and minimum values are not needed nor considered in the resist model. Depending on the mask type, the maximum intensity can be located in the direction outside of the feature polygon while the minimum intensity will be located in the inside direction of the edge, or vice versa. Typically, the slope of the intensity curve is low near the maximum and minimum intensity values.

It is observed that the Iₘₐₓ/Iₘᵢₙ values are located near the centerline of the space/width associated with the fragment. In FIG. 2, the two centerlines (dotted lines), one for width and one for space, coincide with the locations of the Iₘᵢₙ and Iₘₐₓ respectively. The original simulation site has 20 control points (i.e. In=10, Out=9) equidistantly spaced by 20 nm. This site's associated width is 130 nm and space is 240 nm. The Iₘᵢₙ is at 130/2=65 nm, so the optimized number of IN control points is 3 or 4. The Iₘₐₓ is at 240/2=120 nm, so the optimized number of OUT control points is 6. As a result, this edge fragment can get 50% reduction in its control points and consequently 50% in total simulation time if the simulation site shrinks to the region between Iₘₐₓ and Iₘᵢₙ, or the centerlines of the space and the width. For each fragment, the simulation site length may be different due to different widths and/or spaces.

It is also observed that two patterns with the same width value (e.g. 130 nm) but different space values (e.g. one with no neighboring feature and the other with a 180 nm space) both have Iₘᵢₙ near the half width. Thus, the inside and outside parts (with respect to the feature where the edge fragment resides) of the simulation site are somehow independent, showing the feasibility of using the width and space centerlines as the Iₘₐₓ and Iₘᵢₙ locations. Moreover, the method of using the centerlines as Iₘₐₓ and Iₘᵢₙ locations is applicable to fragments on not only 1-D patterns like dense pitches, but also the 2-D patterns like near corners or line ends. Furthermore, while the OPC may shifts edge fragments, the shifting usually does not change the Iₘₐₓ and Iₘᵢₙ locations significantly. The relevant data for all the above observations were presented in M. Bahnas, et al., “Toward faster OPC convergence: Advanced analysis for OPC iterations and simulation environment,” Proc. SPIE 7122, (2008), which is incorporated herein by reference.

There may be a few cases for asymmetric structures in which the OPC shifting won't be symmetric, and consequently the space and width measurements for the fragments involved will change. In most cases the overall length of the site will not be affected but may need a shift in one direction. Practically, the shift in Imax/Imin locations won't be dramatic and the impact on the EPE (edge placement error) calculation will be small, and the final residual EPE may be tolerated. Another option is enhance the algorithm by monitoring the asymmetric shifts per OPC iteration.

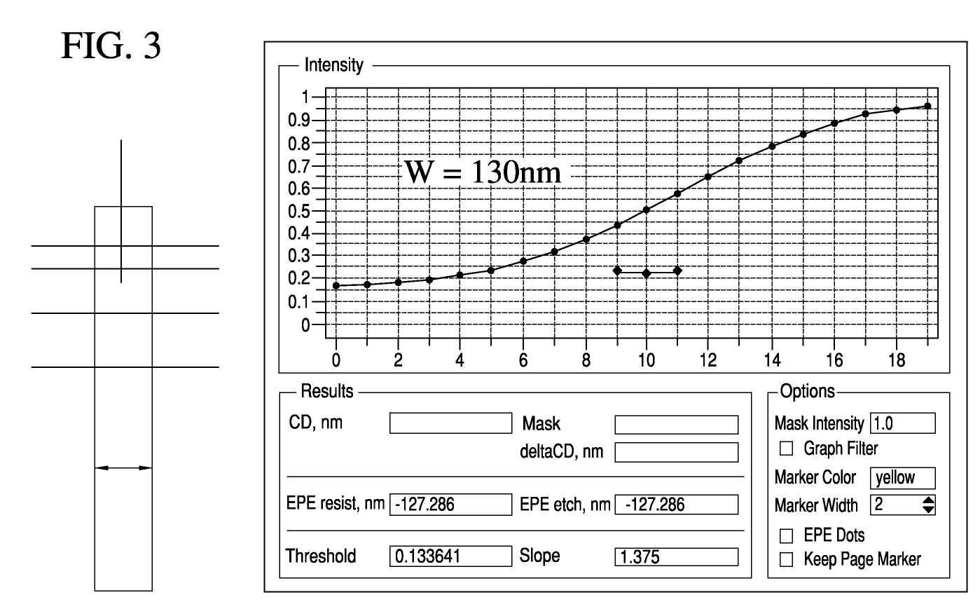

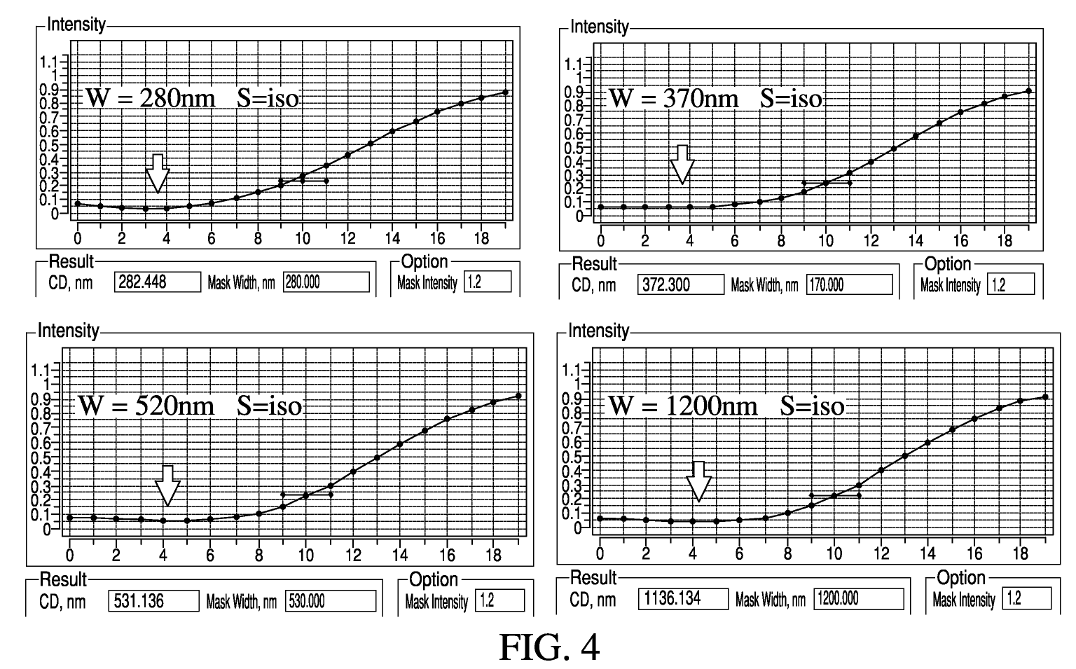

Lengthy simulation sites may be needed for larger spaces and widths. As shown in FIG. 3, the narrow line end is an extreme case since it needs long sites both in- and out-side due to the open space and the large width value. It's possible, however, to set an upper limit for these long sites in the technologies using Attenuating Phase Shift Mask (Att-PSM), since it is experimentally proven that intensity saturates at big spaces and widths. This saturation distance is linked to the technology and optical mask parameters. It can be empirically extracted from scanning through test structures, as shown in FIG. 4. More specifically, for PSM masks with 6% attenuation features, the Iₘᵢₙ saturates at a certain limit for large widths which can be used as the greatest site length from inside. While for PSM masks with 6% attenuation background, the Iₘₐₓ saturates at a certain limit for large spaces which can be used as the greatest site length from outside.

The reference by M. Bahnas, et al. compares OPC results obtained with two traditional methods with a method implementing an embodiment of the invention. The simulation runtime reduction percentage is shown to reach 30-40% and 15-20%, respectively. As for OPC results quality, layouts processed by the different methods show only slight differences.

### Conclusion

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

What is claimed is:

1. A method for determining a simulation site, comprising:
selecting an edge fragment;
determining a maximum intensity location and a minimum intensity location near the edge fragment; and
determining a simulation site for the edge fragment based on the maximum intensity location and the minimum intensity location.

2. The method recited in claim 1, wherein the determining a maximum intensity location and a minimum intensity location is based on an intensity curve along a line perpendicular to the edge fragment.

3. The method recited in claim 1, wherein the determining a maximum intensity location and a minimum intensity location comprises:
determining a first center location between the edge fragment and a first neighboring edge belonging to a neighboring feature;
determining a second center location between the edge fragment and a second neighboring edge belonging to the same feature as the edge fragment; and
designating the first center location and the second center location as the maximum intensity location and the minimum intensity location or the minimum intensity location and the maximum intensity location.

4. The method recited in claim 1, wherein the determining a simulation site for the edge fragment comprises:
determining control points based on the maximum intensity location and the minimum intensity location.

5. A processor-readable medium storing processor-executable instructions for causing one or more processors to perform a method for determining a simulation site, the method comprising:
selecting an edge fragment;
determining a maximum intensity location and a minimum intensity location near the edge fragment; and
determining a simulation site for the edge fragment based on the maximum intensity location and the minimum intensity location.

6. The processor-readable medium recited in claim 5, wherein the determining a maximum intensity location and a minimum intensity location is based on an intensity curve along a line perpendicular to the edge fragment.

7. The processor-readable medium recited in claim 5, wherein the determining a maximum intensity location and a minimum intensity location comprises:
determining a first center location between the edge fragment and a first neighboring edge belonging to a neighboring feature;
determining a second center location between the edge fragment and a second neighboring edge belonging to the same feature as the edge fragment; and
designating the first center location and the second center location as the maximum intensity location and the minimum intensity location or the minimum intensity location and the maximum intensity location.

8. The processor-readable medium recited in claim 5, wherein the determining a simulation site for the edge fragment comprises:
determining control points based on the maximum intensity location and the minimum intensity location.

9. A system comprising one or more processors, the one or more processors programmed to perform a method for determining a simulation site, the method comprising:
selecting an edge fragment;
determining a maximum intensity location and a minimum intensity location near the edge fragment; and
determining a simulation site for the edge fragment based on the maximum intensity location and the minimum intensity location.

10. The system recited in claim 9, wherein the determining a maximum intensity location and a minimum intensity location is based on an intensity curve along a line perpendicular to the edge fragment.

11. The processor-readable medium recited in claim 9, wherein the determining a maximum intensity location and a minimum intensity location comprises:
determining a first center location between the edge fragment and a first neighboring edge belonging to a neighboring feature;
determining a second center location between the edge fragment and a second neighboring edge belonging to the same feature as the edge fragment; and
designating the first center location and the second center location as the maximum intensity location and the minimum intensity location or the minimum intensity location and the maximum intensity location.

12. The processor-readable medium recited in claim 9, wherein the determining a simulation site for the edge fragment comprises:
determining control points based on the maximum intensity location and the minimum intensity location.
